(19) United States
(12) Patent Application Publication
(10) Pub. No.: US 2012/0305604 A1
(43) Pub. Date: Dec. 6, 2012

(54) Nozzle assembly

(76) Inventor: Ya-Tsan Wang, HsinChu City (TW)

(21) Appl. No.: 13/067,496

(22) Filed: Jun. 6, 2011

(51) Int. Cl. G01F 11/00

(52) U.S. Cl. 222/321.9

(57) ABSTRACT

A nozzle assembly includes a main tube, a mounting unit, a valve, a suction unit, a resilient unit and a push unit. The suction unit includes a push rod, a connection rod and a block. The resilient unit is located outside of the push rod so that the resilient unit does not directly contact the liquid which is avoided from being chemically changed. The main tube, the mounting unit and the suction unit are modularized and can be assembled as desired so that the stocking pressure is reduced.

### BACKGROUND OF THE INVENTION

1. Field of the Invention

The present invention relates to a nozzle assembly, and more particularly, to a push-type nozzle assembly for liquid.

2. Background of the Invention

A conventional nozzle assembly 100 is shown in FIG. 7 and generally includes a push mount 101 with an outlet 101a and a cover 102 is connected to the push mount 101. The cover 102 has a suction tube 103 connected thereto and a cone-shaped cap 104 is connected to the suction tube 103. A tube 105 extends through the cone-shaped cap 104 which seals the holes 105a of the tube 105. A spring 106 is connected to the tube 105 and a bead 107 is engaged with the spring 106. A reception tube 108 accommodates the suction tube 103, the cone-shaped cap 104, the tube 105, the spring 106 and the bead 107 therein. A hose 109 is connected to the reception tube 108.

By pushing the push mount 101 to le the air in the container escape from the outlet 101a and the lower pressure sucks the liquid in the container into the reception tube 108 via the hose 109. The spring 106 is compressed and the bottom of the tube 105 contacts the bead 107 which seals the hole 108a of the reception tube 108 such that a gap is defined between the tube 105 and the cone-shaped cap 104. The liquid in the reception tube 108 enters into the tube 105 via the hole 105a and the gap. The liquid is then sucked and escapes from the outlet 101a via the suction tube 103. When releasing the push mount 101, the liquid in the reception tube 108 flows back to the container.

Although the conventional push-type nozzle assembly 100 can suck the liquid and spray the liquid from the nozzle, the spring 106 and the bead 107 made by metal and are in contact with the liquid directly and may cause chemical change to the liquid and/or be harmful to the users. Another improved nozzle assembly 200 is disclosed in FIG. 8 and includes a spring 203 located between the push mount 201 and the cover 202 to avoid the spring 203 from directly contacting the liquid, and the metallic bead is omitted. However, the spring 203 located between the push mount 201 and the cover 202 makes the assembly to be complicate and difficult to be assembled. The amount of the liquid that is sucked by one push is reduced so that the users have to operate many times to get sufficient amount of the liquid.

The present invention intends to provide a nozzle assembly to improve the shortcomings of the above mentioned conventional nozzle assemblies.

### SUMMARY OF THE INVENTION

The present invention relates to a nozzle assembly and comprises a main tube, a mounting unit, a valve, a suction unit, a resilient unit and a push unit. The main tube is a tubular member with two sections of different diameters. A hose is connected to the main tube which has a top room and a bottom room which has a smaller diameter than that of the top room. A first connection portion extends from the first end of the main tube and an opening is defined in the second end of the main tube. The mounting unit has a mount and a seal sleeve, wherein the mount is connected to a container and the seal sleeve is mounted to the main tube. The seal sleeve has a second connection portion which is connected with the first connection portion. A passage is defined between the first and second connection portions. A second contact portion is formed in the passage. A valve is located in the bottom room of the main tube and movable to seal the passage. A suction unit is located in the top room and has a push rod, a connection rod and a block. The push rod is a hollow rod and has a connection portion and an insertion respectively on two ends thereof. A first contact portion extends from the outside of the push rod. The connection rod has a cylindrical portion inserted into the push rod. The cylindrical portion has multiple axial paths defined in the outer surface thereof. The connection rod has a stop on a lower section thereof. The block is movably mounted to the insertion and has an annular portion which is sealed with the stop. The resilient unit is mounted to the movable rod and biased between the first contact portion and the second contact portion. The push unit is connected to the connection portion of the push rod and has a nozzle defined therein. A force of the push unit moves the block and the connection rod back and forth in axial direction.

The resilient unit is located outside of the push rod so that the resilient unit does not directly contact the liquid which is avoided from being chemically changed. The main tube, the mounting unit and the suction unit are modularized and can be assembled as desired so that the stocking pressure is reduced.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the nozzle assembly of the present invention;

FIG. 2 is a cross sectional view of the nozzle assembly of the present invention;

FIG. 3 is a cross sectional view to show that the push unit is pushed downward;

FIG. 4 is a cross sectional view to show that the push unit is released and bounces upward;

FIG. 5 is a cross sectional view of a second embodiment of the push-type nozzle assembly of the present invention;

FIG. 6 is a cross sectional view to show the second embodiment of the push-type nozzle assembly of the present invention;

FIG. 7 is an exploded view to show a conventional nozzle assembly, and

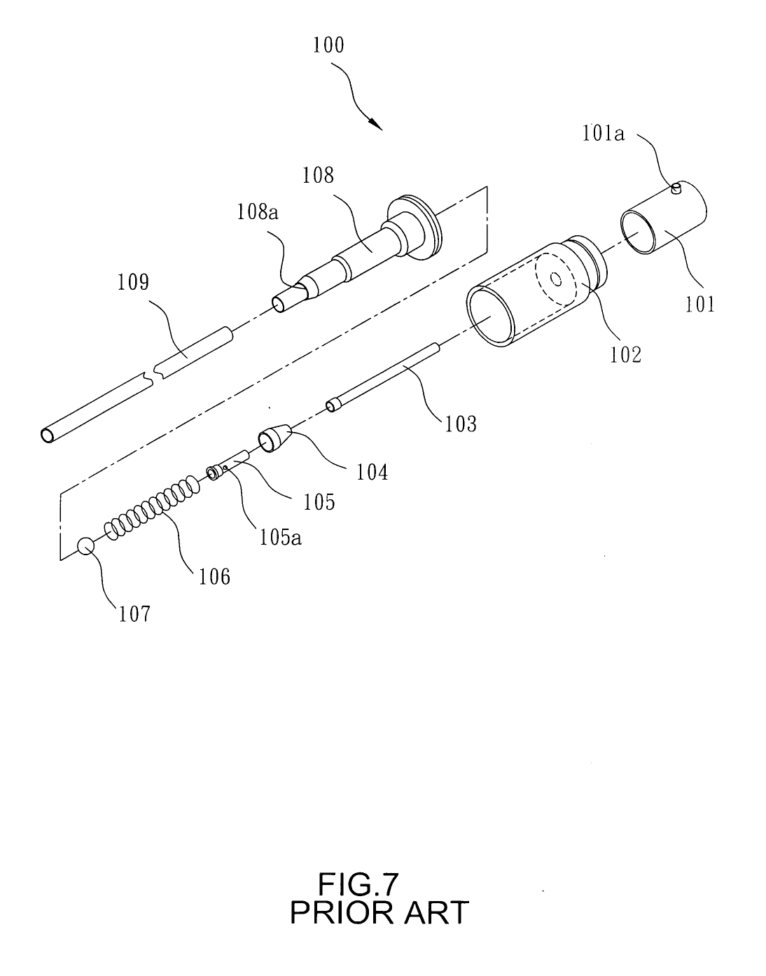

FIG. 8 is a cross sectional view of another conventional nozzle assembly.

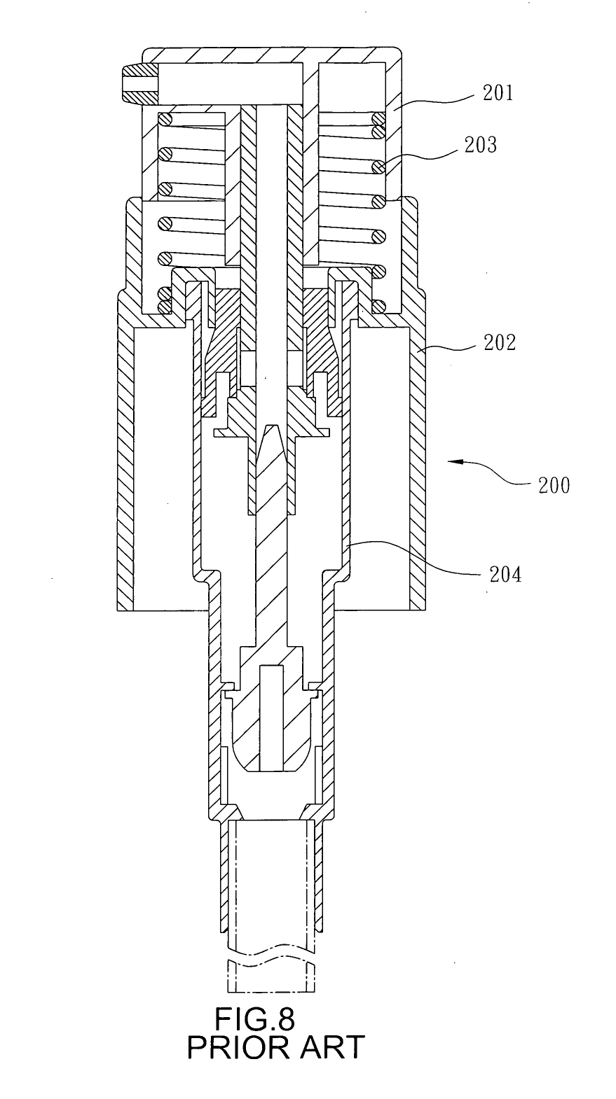

### DETAILED DESCRIPTION OF THE PREFERRED EMBODIMENT

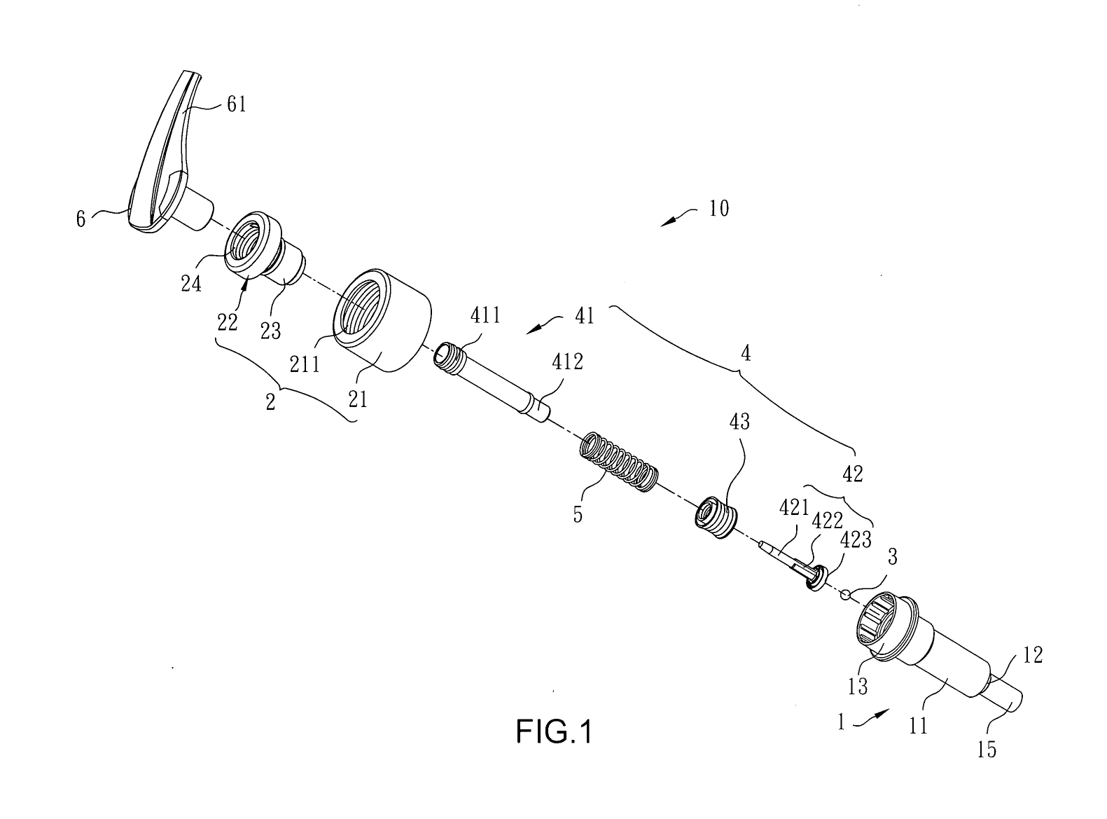

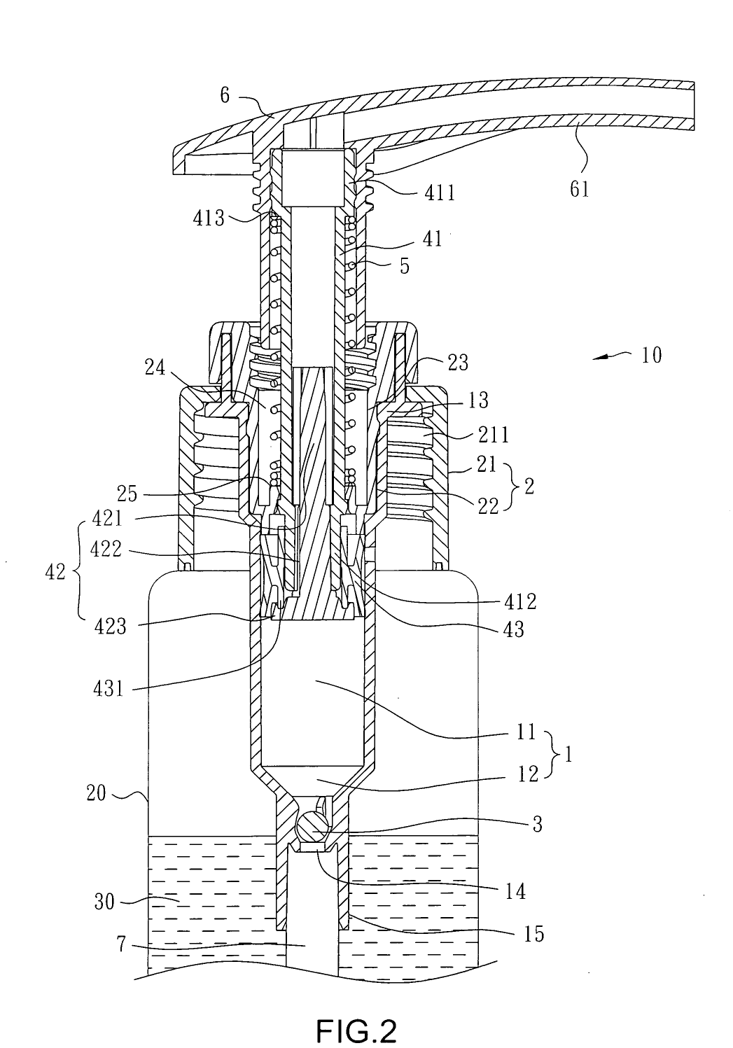

Referring to FIGS. 1 and 2, the nozzle assembly 10 of the present invention is to be connected to the open top of a container 20 so as to suck the liquid 30 in the container 20 out from the nozzle. The nozzle assembly 10 comprises a main tube 1, a mounting unit 2, a valve 3, a suction unit 4, a resilient unit 5 and a push unit 6. The main tube 1 is a tubular member with two sections of different diameters, and a first connection portion 13 extends from the first end of the main tube 1 and an opening 14 is defined in the second end of the main tube 1. The main tube 1 has a reception portion 15 and a hose 7 is connected to the reception portion 15.

The mounting unit 2 has a mount 21 which is threadedly connected to the open top of the container 20, and a seal sleeve 22. The mount 21 includes a threaded portion 211 so as to be threadedly connected to the open top of the container 20. The seal sleeve 22 is mounted to the main tube and has a second connection portion 23 which is connected with the first connection portion 13. A passage 24 is defined between the first and second connection portions 13, 23, and a second contact portion 25 is formed in the passage 24.

The valve 3 is located in the bottom room 12 of the main tube 1 and movable to seal the passage 14 by an up and down movement. As shown in the drawing, the valve 3 is a bead.

The suction unit 4 is located in the top room 11 and has a push rod 41, a connection rod 42 and a block 43, wherein the push rod 41 is a hollow rod and has a connection portion 411 and an insertion 412 respectively on two ends thereof. A first contact portion 413 extends from the outside of the push rod 41. The connection rod 42 has a cylindrical portion 421 inserted into the push rod 41. The cylindrical portion 421 has multiple axial paths 422 defined in the outer surface thereof. The connection rod 42 has an annular and flat stop 423 on the lower section thereof. The block 43 is movably mounted to the insertion 412 and has an annular portion 431 which is sealed with the stop 423.

The resilient unit 5 is mounted to the push rod 41 and biased between the first contact portion 413 and the second contact portion 25.

The push unit 6 is connected to the connection portion 411 of the push rod 41 and has a nozzle 61 defined therein so that the liquid 30 is released from the nozzle 61. By pushing the push unit 6 or by the force of the resilient unit 5, the block 43 and the connection rod 42 move back and forth in axial direction.

The resilient unit 5 is located outside of the push rod 41 that the resilient unit 5 does not directly contact the liquid 30 which is avoided from being chemically changed. The main tube 1, the mounting unit 2 and the suction unit 4 are modularized and can be assembled as desired so that the stocking pressure is reduced.

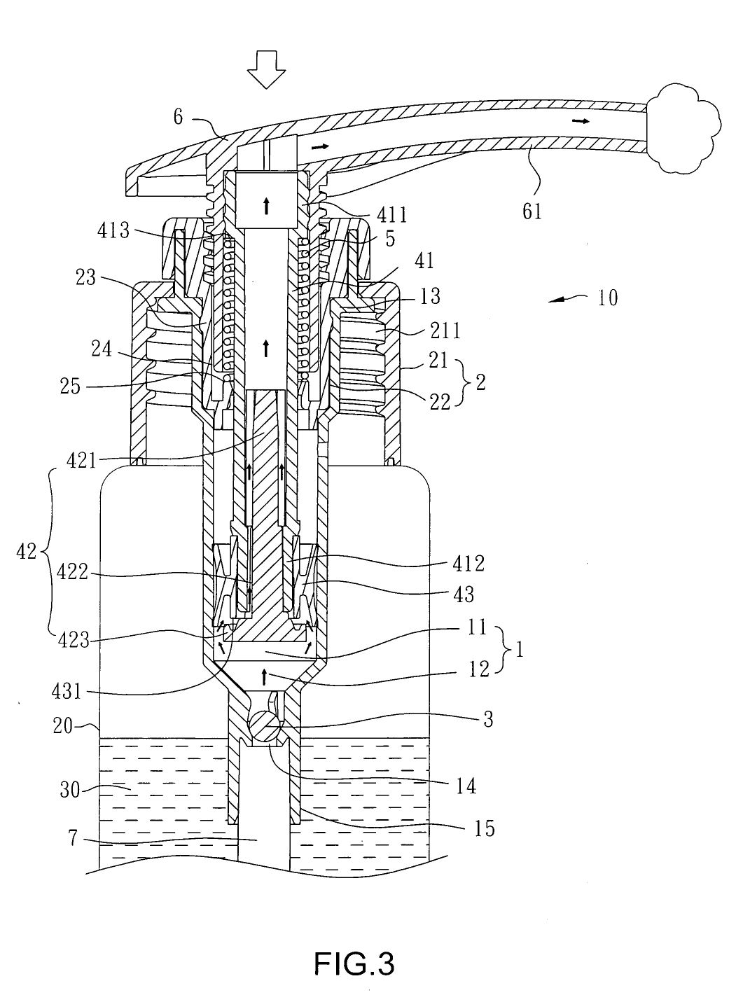

As shown in FIG. 3, when the push unit 6 is pushed downward, the push rod 41 and the connection rod 42 of the suction unit 4 are lowered, and the space of the top room 11 of the main tube 1 is reduced. The liquid pressure is sufficient to push the valve 3 to move downward to seal the opening 14 so that the main tube 1 is sealed. The stop 423 of the connection rod 42 and the annular portion 431 of the block 43 are separated because of the downward movement of the connection rod 42. The paths 422 in the connection rod 42 are exposed and the liquid 30 passes through the push rod 41 and escapes from the nozzle 61 of the push unit 6.

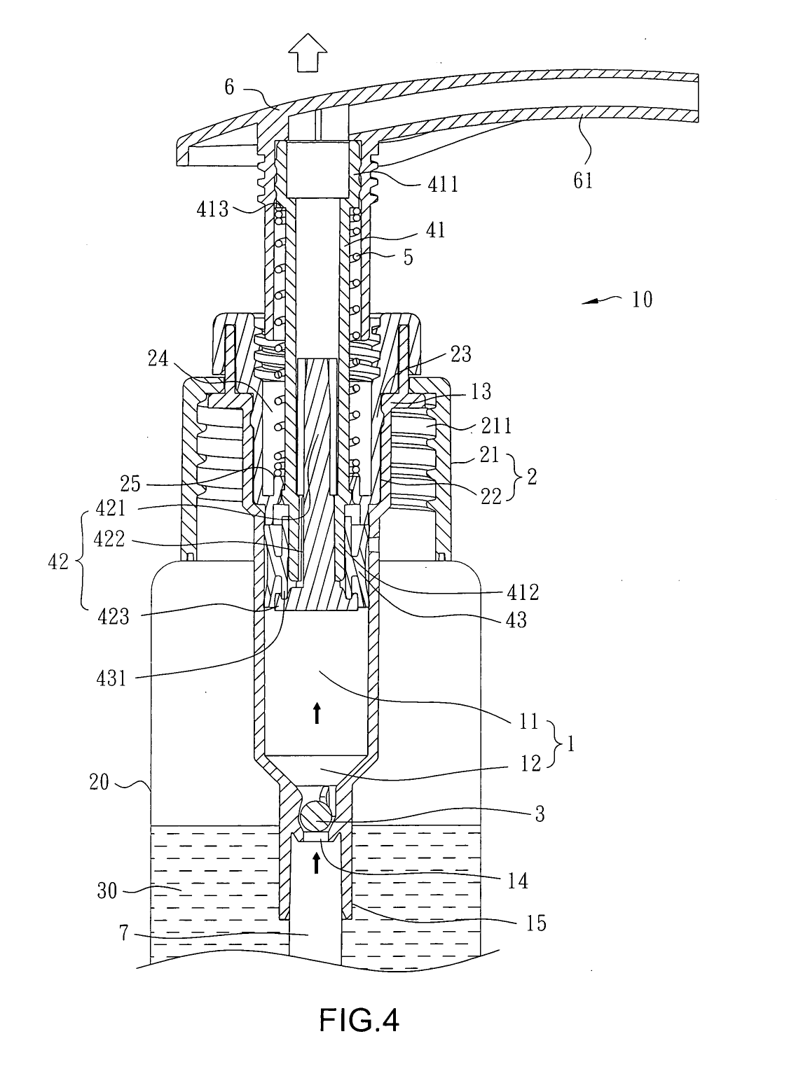

As shown in FIG. 4, when the push unit 6 is released, the resilient unit 5 pushes the push rod 41 and the connection rod 42 upward, so that the stop 423 of the connection rod 42 and the annular portion 431 of the block 43 are sealed to each other. The pressure in the top room 11 is lower than that of outside, the liquid 30 in the container 20 pushes the valve 3 from the opening 14 and the valve 3 is sucked into the top room 11 and ready for the next push.

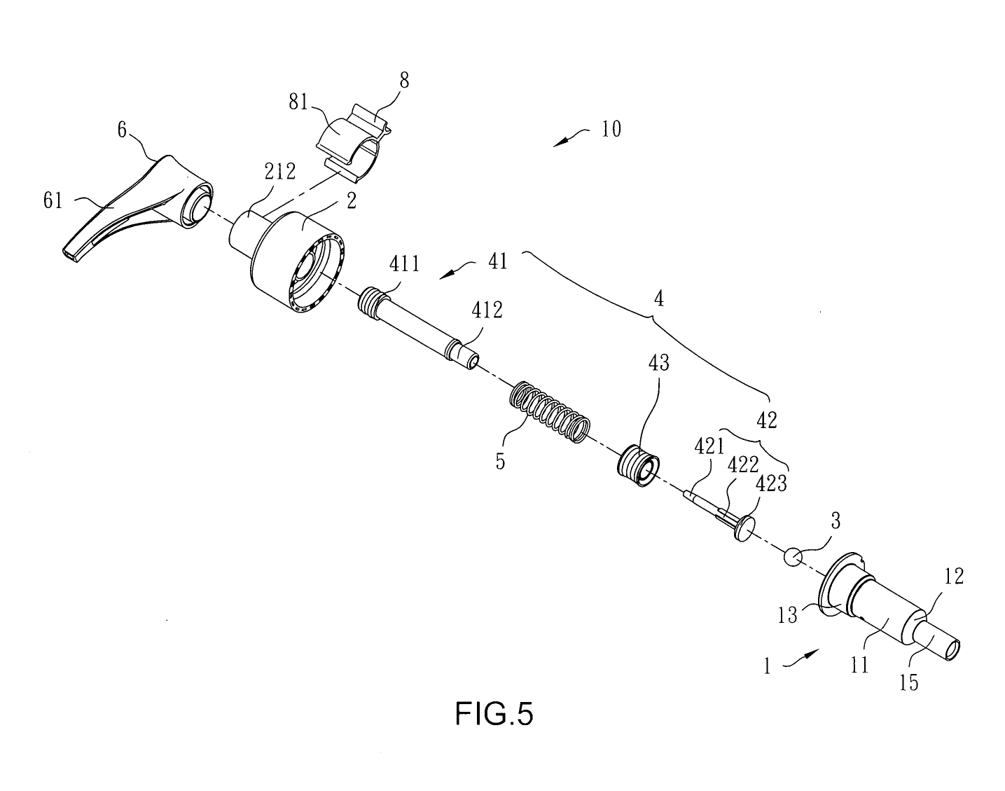

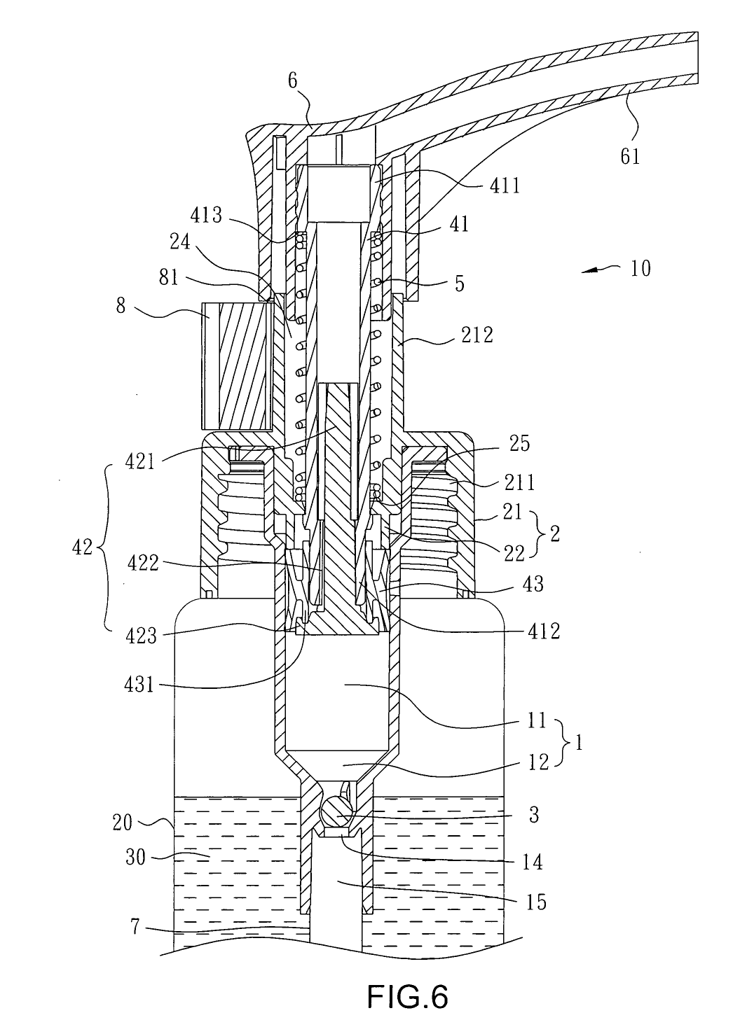

FIGS. 5 and 6 show the second embodiment of the present invention, wherein the nozzle assembly comprises a main tube 1, a mounting unit 2, a valve 3, a suction unit 4, a resilient unit 5 and a push unit 6. It is noted that the mount 21 is integrally formed with the seal sleeve 22. The nozzle assembly 10 has a fixing member 8 which has a clamp 81, and the mounting unit 2 has a tubular portion 212, the clamp 81 clamps the tubular portion 212 so as to stop the push unit 6. This prevents the push unit 6 from being unintentionally pushed.

While we have shown and described the embodiment in accordance with the present invention, it should be clear to those skilled in the art that further embodiments may be made without departing from the scope of the present invention.

What is claimed is:

1. A nozzle assembly comprising:
a main tube being a tubular member with two sections of different diameters, a hose connected to the main tube which has a top room and a bottom room which has a smaller diameter than that of the top room, a first connection portion extending from a first end of the main tube and an opening defined in a second end of the main tube;
a mounting unit having a mount and a seal sleeve, the mount adapted to be connected to a container and the seal sleeve mounted to the main tube, the seal sleeve having a second connection portion which is connected with the first connection portion, a passage defined between the first and second connection portions, a second contact portion formed in the passage;
a valve located in the bottom room of the main tube and movable to seal the passage;
a suction unit located in the top room and having a push rod, a connection rod and a block, the push rod being a hollow rod and having a connection portion and an insertion respectively on two ends thereof, a first contact portion extending from an outside of the push rod, the connection rod having a cylindrical portion inserted into the push rod, the cylindrical portion having multiple axial path defined in an outer surface thereof, the connection rod having a stop on a lower section thereof, the block movably mounted to the insertion and having an annular portion which is sealed with the stop;
a resilient unit mounted to the movable rod and being biased between the first contact portion and the second contact portion, and
a push unit connected to the connection portion of the push rod and having a nozzle defined therein, a force of the push unit moving the block and the connection rod back and forth in axial direction.

2. The assembly as claimed in claim 1, wherein the mount includes a threaded portion which is adapted to be secured to an open top of the container.

3. The assembly as claimed in claim 1, wherein the main tube has a reception portion and the hose is connected to the reception portion.

4. The assembly as claimed in claim 1, wherein the valve is a bead.

5. The assembly as claimed in claim 1, wherein the stop is an annular and flat part.

6. The assembly as claimed in claim 1, wherein the mount is integrally formed with the seal sleeve.

7. The assembly as claimed in claim 6 further comprising a fixing member which has a clamp, the mounting unit has a tubular portion, the clamp clamps the tubular portion so as to stop the push unit.
